(19) United States
(12) Patent Application Publication
(10) Pub. No.: US 2020/0034832 A1
(43) Pub. Date: Jan. 30, 2020

(54) TOKENIZATION DEVICES, SYSTEMS, AND METHODS

(71) Applicant: Verizon Patent and Licensing Inc., Arlington, VA (US)

(72) Inventors: John L. KORPAL, Highlands Ranch, CO (US); Carrie L. ARNOLD, Swoyersville, PA (US)

(21) Appl. No.: 16/049,414

(22) Filed: Jul. 30, 2018

(51) Int. Cl. G06Q 20/38; G06Q 20/34; G06Q 20/40

(52) U.S. Cl. CPC G06Q 20/383; G06Q 2220/00; G06Q 20/4012; G06Q 20/356

(57) ABSTRACT

A device receives clear text data for long-term tokenization and an indication to discontinue long-term tokenization of the clear text data. The device implements a tokenization continuity mode based on receiving the indication to discontinue long-term tokenization of the clear text data. Implementing the tokenization continuity mode can include obtaining an identifier for use during the tokenization continuity mode, generating a temporary token associated with the clear text data, and storing the temporary token and the clear text data. The temporary token includes the identifier. The device receives an indication to terminate the tokenization continuity mode, generates a long-term token associated with the clear text data based on receiving the indication to terminate the tokenization continuity mode, and replaces the temporary token with the long-term token.

### BACKGROUND

Entities that store, process, and/or transmit sensitive data have an obligation to keep the sensitive data safe and secure. As an example, the Payment Card Industry (PCI) has created an information security standard (i.e., the PCI Standard) whereby card issuers, merchants, and service providers can be required to demonstrate compliance with strict levels of security when storing, processing, and/or transmitting sensitive data.

### BRIEF DESCRIPTION OF THE DRAWINGS

FIGS. 1A-1D are diagrams of an example implementation described herein.

FIG. 2 is a diagram of an example environment in which the devices, systems, and/or methods, described herein, can be implemented.

FIG. 3 is a diagram of example components of one or more devices of FIG. 2.

FIG. 4 is a flow chart of an example process for implementing a tokenization continuity mode by a tokenization device.

### DETAILED DESCRIPTION OF PREFERRED EMBODIMENTS

The following detailed description of example implementations refers to the accompanying drawings. The same reference numbers in different drawings can identify the same or similar elements.

Sensitive data can enter a network as clear text data. The clear text data can be encrypted and transmitted from one system to another system in the network. Devices associated with each system in the network can decrypt and re-encrypt the clear text data until the clear text data is processed (e.g., to complete a purchase, etc.). For example, a customer can, using a customer device, enter a credit card number as clear text data when making a purchase from a merchant. A browser on the customer's device can encrypt the clear text data and transmit the encrypted clear text data to the merchant's server, which can decrypt the encrypted clear text data, and send the clear text data to a transaction backend device for processing, authorizing, and/or completing the purchase. Each time a network device receives and/or transmits encrypted clear text data, the clear text data is likewise decrypted, making the clear text data available in a readable format at multiple points in a network and, thus, susceptible to being obtained by a hacker. As the number of devices receiving and/or decrypting the clear text data in the network increases, so does the risk that one or more malicious hackers can obtain the clear text data, and use the clear text data to commit fraud, a crime, an attack, and/or the like.

Some implementations described herein include a tokenization system or device, such as a tokenization gateway, that obtains clear text data and tokenizes the clear text data. The tokenized data (i.e., tokenized clear text data) can be sent to external devices for processing and can only be detokenized in instances where an external device is unable to process the tokenized data. In this way, the tokenization gateway can establish a protected zone within a network, whereby the tokenization gateway can control devices having access to the clear text data. In this way, the number of devices having access to the clear text data can be reduced or minimized. The tokenization gateway can send tokenized data for storage by external devices, thereby obviating storage of the clear text data by the external devices. In this way, unauthorized access of the clear text data by hackers and/or attackers can be reduced or minimized.

Some implementations described herein provide a tokenization gateway, that is configured to implement a tokenization continuity mode in response to the occurrence of an event, such as the occurrence of an error or failure of a tokenization engine associated with the tokenization gateway. During the tokenization continuity mode, the tokenization gateway can access or obtain a preexisting and/or a predefined identifier for use during the tokenization continuity mode, and generate temporary tokens based on the identifier for tokenizing the clear text data received by the tokenization gateway using the temporary tokens. In this way, the clear text data received by the tokenization gateway can be tokenized using the temporary tokens, despite the tokenization engine being unavailable or offline. In this way, the tokenization gateway can maintain control over devices having access to the clear text data, and transmit the temporary tokens for storage by external devices, thus, obviating storage of the clear text data by the external devices. In this way, the security associated with accessing the clear text data can be increased, which can inhibit unauthorized access of the clear text data by malicious actors. Upon termination of the tokenization continuity mode, the tokenization gateway can generate long-term tokens associated with the clear text data and replace the temporary tokens with the long-term tokens.

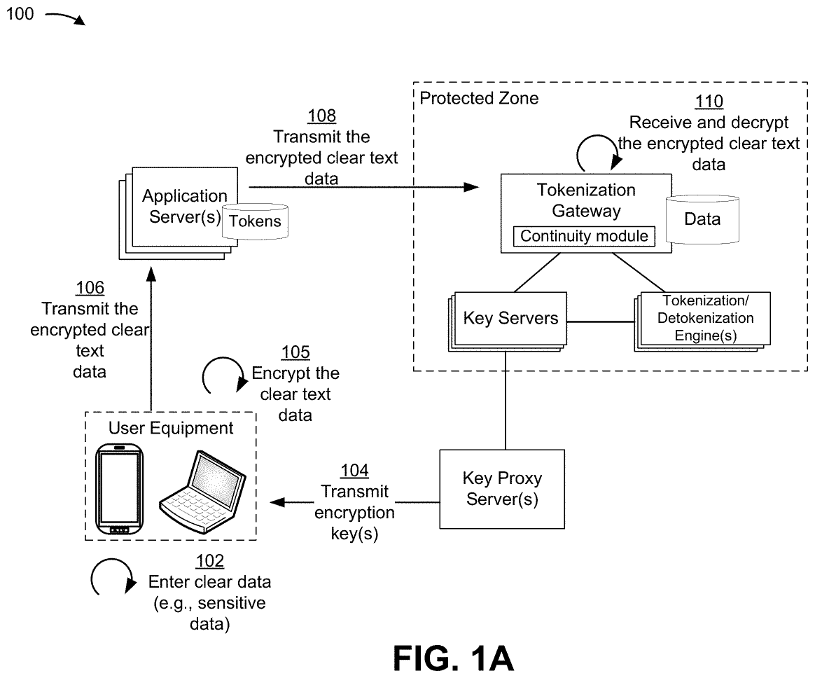

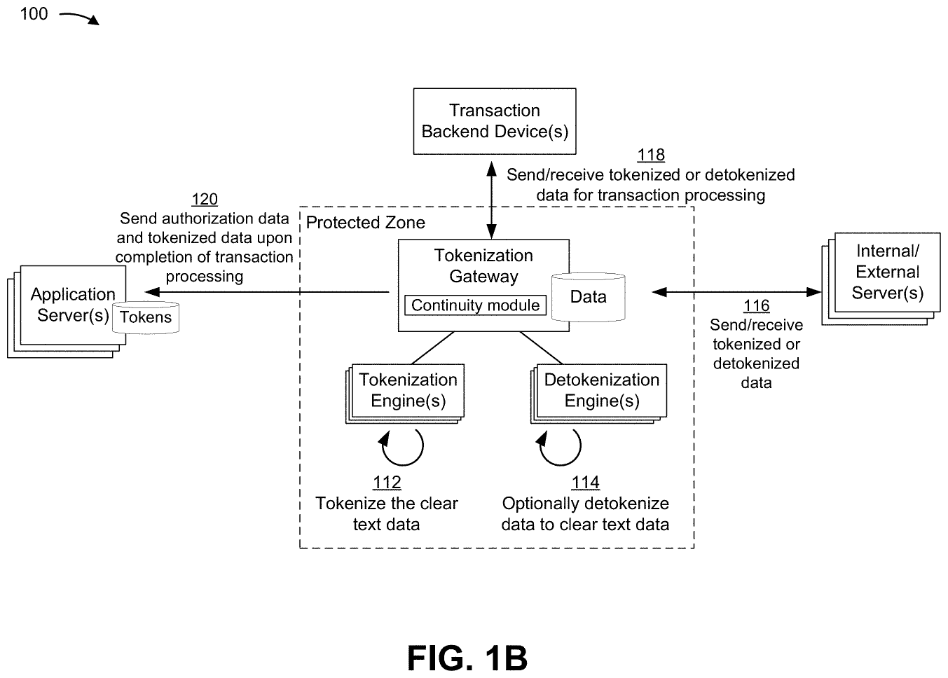

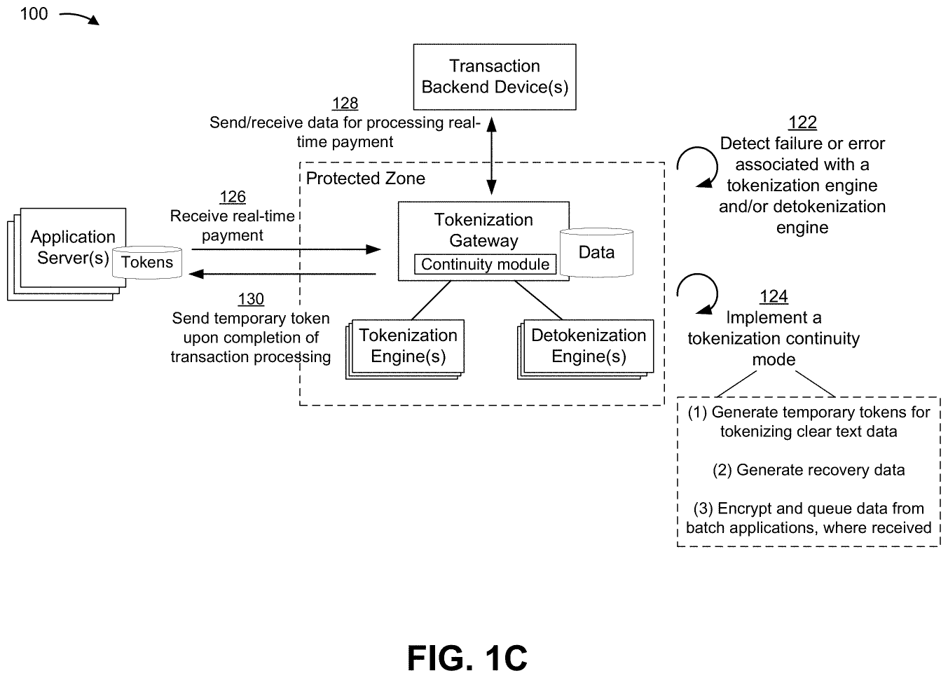

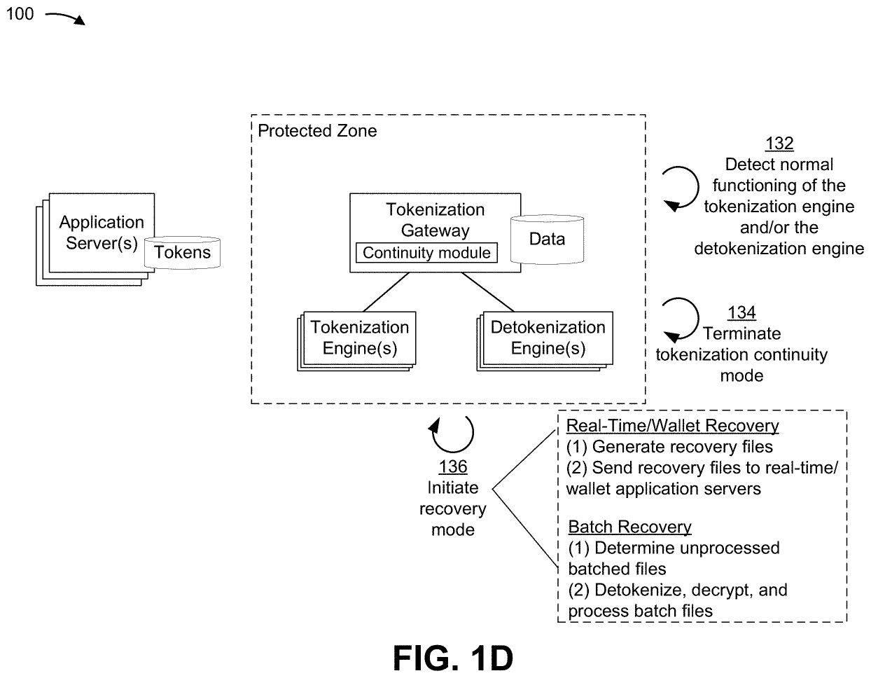

FIGS. 1A-1D are diagrams of an example implementation 100 described herein. As shown in FIG. 1A, user equipment (e.g., a computer, a smart device, a phone, a wearable computer, etc.), an application server, a key server, and a key proxy server can be associated with a tokenization gateway. The user equipment, application server, key server, key proxy server, and tokenization gateway can communicate using wired or wireless connections facilitated by at least one network, which can include, without limitation, a cellular network, a public network, a private network, an intranet, the Internet, a fiber optic-based network, a cloud computing network, or the like, and/or a combination of these or other types of networks as described herein.

In some implementations, the tokenization gateway can reside within a protected zone of a network as described herein, by which the tokenization gateway, using at least one tokenization engine and at least one detokenization engine, can decrypt, encrypt, tokenize, and/or transmit tokenized versions of the clear text data (i.e., tokenized data). In this way, the tokenization gateway can manage and control access to the clear text data and/or devices tokenizing and/or detokenizing the clear text data, so that external applications can receive the tokenized data (e.g., tokens) in place of the clear text data.

As shown in FIG. 1A, and by reference number 102, a user, by way of user equipment, can enter clear text data. In some implementations, the clear text data being entered by the user includes sensitive data. As an example, the user, using the user equipment, can enter clear text data in the form of a credit card number used to make a purchase from a merchant by way of transmitting encrypted credit card number to the application server.

In some implementations, the user equipment can include a computer, a phone (e.g., a smart phone), a wearable computer (e.g., a wearable computer watch, wearable computer eyeglasses, etc.), and/or the like, by which the user can access and communicate with the application server. In some implementations, the user can enter the clear text data using a user interface disposed on and/or associated with the user equipment. For example, the user can enter the clear text data using a touch screen interface, a keypad, a keyboard, and/or the like.

As further shown in FIG. 1A, and by reference number 104, the user device, or a mobile application executed by the user equipment (e.g., a wallet application, a web browser, a browser, etc.) can request, and the key proxy server can send, one or more encryption keys for encrypting the clear text data entered by the user. For example, the encryption keys can include a single-use, short-term (e.g., a short lived) hash or key that can be used to encrypt the clear text data prior to or simultaneous with the clear text data being transmitted to the application server. In some implementations, the encryption key used by the user equipment, or the mobile application executed by the user equipment, to encrypt the clear text data can expire in less than one hour, less than four hours, less than twenty-four hours, less than seventy-two hours, and/or the like. Upon expiration of the encryption key, the user can be prompted to reenter the clear text data for completing a transaction (e.g., a payment transaction).

As further shown in FIG. 1A, and by reference number 105, the clear text data can be encrypted using the one or more encryption keys received from the key server. In some implementations, the encryption key can be used to encrypt the clear text data entered by the user, in advance of the application server receiving and/or storing the clear text data (i.e., the unencrypted clear text data) entered by the user. For example, the clear text data can be encrypted based on an encryption hash or algorithm that combines sensitive text of the clear text data with a random key having a single-use. In some implementations, one or more encryption services can be implemented such as, for example, ODI services, SAP services, Java Web Services, Unix shell script, and/or the like for encrypting the clear text data obtained by the application server. In this way, the application server can receive an encrypted version of the clear text data, instead of the clear text data.

As further shown in FIG. 1A, and by reference number 106, the user equipment can transmit, and the application server can receive, the encrypted clear text data. The encrypted clear text data can be used, by the application server, to initiate a transaction, such as a purchase transaction. In some implementations, the application server includes a merchant server by which the user, using the user equipment, can initiate and make the purchase transaction.

As further shown in FIG. 1A, and by reference number 108, the application server can transmit the encrypted clear text data to the tokenization gateway. In some implementations, the encrypted clear text data can be transported through a network by way of a cryptographic protocol. For example, a transport layer security (TLS) protocol can be used to transport the encrypted clear text data to the tokenization gateway. In some implementations, the TLS protocol can employ symmetric encryption based on a shared secret negotiated at the start of a session (e.g., by a TLS handshake) between the application server and the tokenization gateway. In this way, the clear text data can be protected using a multi-layered security approach, such as a double encryption approach, which can include both the single-use encryption of the clear text data using the encryption key provided by the key proxy server and the TLS transport for more secure transmission through the network. In some implementations, the application servers and the tokenization gateway are owned, operated, managed, and/or controlled by different entities (e.g., different controllers, different owners, different operators, etc.), which improves the level of security associated with managing the clear text data via a separation of powers and/or duties.

As further shown in FIG. 1A, and by reference number 110, the tokenization gateway can receive the encrypted clear text data and decrypt the encrypted clear text data to obtain the clear text data. In some implementations, the tokenization gateway can obtain the key for decrypting the encrypted clear text data from the key server. For example, the tokenization gateway can obtain the decryption key to decrypt the encrypted clear text data by sending a request, a call, and/or the like, to the key server, which can include authenticating information used to obtain the decryption key from the key server.

Turning now to FIG. 1B, and as shown by reference number 112, in some implementations, the tokenization gateway can tokenize the clear text data. Additionally, or, alternatively, the tokenization gateway can tokenize the clear text data upon using the clear text data to perform a transaction, such as upon the authorization and/or completion of a payment transaction.

In some implementations, the tokenization gateway can, using a tokenization engine, replace one or more sensitive values of the clear text data with one or more long-term, non-sensitive token values or tokens. For example, the tokens generated by the tokenization engine can include non-sensitive values, and, thus, have no value to a hacker or attacker. In some implementations, the tokenization engine is configured to generate long-term tokens, which are useful in providing long-term tokenization of the clear text data, and can be used multiple times. For example, the tokens generate by the tokenization engine can include specific long-term tokens that represent specific clear text data values, and can be used to track the specific clear text data values across multiple transactions and/or represent the specific clear text data values across the multiple transactions.

In some implementations, the tokens generated by the tokenization engine can be stored in a data structure, whereby the tokens can be mapped to the clear text data. That is, in some implementations, specific tokens (or token values) can be mapped to specific clear text data (or clear text data values) and stored in the data structure for use many times for many different transactions. In this way, the specific clear text data can be mapped to the specific token within the tokenization system implemented by the tokenization gateway. In some implementations, the data structure, in which the mappings of the clear text data and the tokens are stored (e.g., the data at rest), can be encrypted using transparent data encryption (TDE), whereby the data may not be obtained without an encryption certificate and/or a master key. In this way, unauthorized access of the mappings can be reduced or obviated.

Still referring to FIG. 1B, and in some implementations, the tokenization gateway can access, for example, the tokenization engine, to generate mathematically reversible cryptographic tokens using a mathematically reversible cryptographic function. The mathematically reversible cryptographic function can be based on a known cryptographic algorithm and a cryptographic key. Additionally, or alternatively, in some implementations, the tokens can be generated using a one-way, non-reversible cryptographic function (e.g., a hash function), using an assignment through an index function, an assignment through a sequence number, or an assignment through a randomly generated number that is not mathematically derived from the clear text data. In some implementations, the tokens generated based on the clear text data include values that inhibit recovery of the clear text data based on knowledge of the tokens alone, as the clear text data may not be computationally feasible based on knowledge of the tokens alone, or knowledge of a number of tokens. In some implementations, the tokens generated by the tokenization engine have no value if compromised or stolen, and can be unusable by a hacker or attacker if a device storing the tokens becomes compromised.

As further shown in FIG. 1B, and by reference number 114, in some implementations, the tokenized data is optionally detokenized back to the clear text data prior to sending the clear text data for processing by the transaction backend device (e.g., a backend server) and/or an internal or external server residing in an internal or external system. Alternatively, the clear text data may not be detokenized prior to sending the clear text data for processing by the transaction backend device and/or an internal or external server residing in an internal or external system, as such devices (e.g., the transaction backend device and/or the internal or external servers) can be configured to process the tokenized data in performing services based on the data and/or in authorizing and/or completing transactions based on the data.

In some implementations, the tokenized data can be detokenized by virtue of obtaining the mappings of the tokens to the clear text data, the mappings of which can be stored in the data structure (e.g., a database, a vault, a cache, a memory element, etc.) assessable to the detokenization engine of the tokenization gateway. In some implementations, the mappings can facilitate detokenization of the clear text data by the detokenization engine, which can access, obtain, and/or retrieve the clear text data based on the mappings. For example, the detokenization engine of the tokenization gateway can query the data structure containing the clear text data and the tokens to obtain and/or retrieve clear text data associated with a token. In some implementations, the ability to tokenize and detokenize the clear text data can be controlled, contained, and/or encapsulated in the protected zone by way of the tokenization system implemented by the tokenization gateway. Stated differently, in some implementations, the tokenization gateway can manage, control, and/or restrict access of the clear text data by external systems and/or devices, including, for example, the application servers, to preclude such systems and/or devices from acquiring and/or storing the clear text data. In this way, the clear text data can be unavailable for access by a hacker or malicious actor. In this way, the systems and/or devices outside of the protected zone can be outside of the scope for compliance with a Payment Card Industry (PCI) standard. In this way, computing resources (e.g., processors and memory) that would otherwise be required to assess, monitor, and/or manage compliance with the PCI standard can be reduced and/or obviated.

As further shown in FIG. 1B, and by reference number 116, the tokenization gateway and one or more internal or external servers can communicate tokenized or detokenized data. In some implementations, the internal or external servers can be associated with a vendor, merchant, account manager, or service provider configured to obtain the clear text data or the tokenized data in order to perform one or more services. In some implementations, the internal or external servers can perform account analytics, credit score analytics, loan approvals, credit monitoring services, user account management services, user account monitoring services, and/or the like, based on the clear text data or the tokenized data.

As an example, the tokenization gateway can detokenize the clear text data, and send the clear data to an internal or external server for credit monitoring. As another example, the tokenization gateway can send the tokenized data to the internal or external server for account monitoring based on the internal or external server being configured to process the tokenized data. As a further example, the tokenization gateway can receive clear text data from the internal or external server. Upon receiving the clear text data from the internal or external sever, the tokenization gateway can tokenize the clear text data based on an existing token or a newly generated token, and store a mapping of the clear text data to the token in a data structure. As yet a further example, the tokenization gateway can receive tokenized data from the internal or external server and detokenize the data based on a mapping of the tokenized data to clear text data.

As further shown in FIG. 1B, and by reference number 118, the tokenization gateway and the transaction backend device can communicate tokenized or detokenized data to facilitate authorization and/or completion of a transaction (e.g., a purchase transaction), based on processing the tokenized or detokenized data. For example, the transaction backend device can be associated with a financial institution (e.g., a banking entity, a payment card association, etc.) that can receive the clear text data or the tokenized data, and process the clear text data or the tokenized data to facilitate a payment transaction. As an example, the tokenization gateway can obtain clear text data from an application server, and transmit the clear text data to the transaction backend device for processing to facilitate the payment transaction. As another example, the tokenization gateway can transmit the tokenized data to the transaction backend device for processing to facilitate the payment transaction. Upon processing the clear text data or the tokenized data to facilitate the payment transaction, the transaction backend device can transmit an authorization identifier (e.g., an authorization code) to the tokenization gateway, based on authorizing and/or completing the payment transaction.

In some implementations, transactions completed based on the clear text data communicated by the tokenization gateway to the transaction backend device can be logged for monitoring and/or managing points of ingress and/or egress of the clear text data relative to the tokenization gateway and/or the protected zone embodied by the tokenization gateway. In this way, information regarding completed transactions can be used to detect and/or prevent possible attempts by malicious actors to obtain the clear text data.

As further shown in FIG. 1B, and by reference number 120, the tokenization gateway can tokenize the clear text data used to complete a payment transaction, and send the tokenized data and the authorization identifier to the application server upon authorization and/or completion of the payment transaction. The application server can store the authorization identifier and the tokenized data. In some implementations, the tokenized data can be stored in place of the clear text data. In this way, the application server can be precluded from obtaining and/or storing the clear text data. In this way, unauthorized access of the clear text data by way of hacking or attacking the application server can be reduced, minimized, and/or obviated. In this way, the tokenization gateway can maintain control over the clear text data when the clear text data is within the protected zone established by the tokenization gateway, to further reduce the opportunity for malicious actors to obtain the clear text data. In this way, the application server, receiving the tokenized data instead of the clear text data, can be removed from the scope of compliance with the PCI standard, which can conserve computing and/or processing resources in the network.

In this way, the number of devices that store, process, and/or transmit clear text data outside of the protected zone implemented or established by the tokenization gateway can be reduced. In this way, the opportunity for hackers and/or malicious actors to obtain the clear text data can be reduced or minimized, which increases the overall security of information in a network. The tokenization gateway can manage and control access to the tokenization engine(s) and the detokenization engine(s), whereby access can be granted upon the successful presentation of two or more factors (e.g., knowledge-based factors, device-based factors, biometric-based factors, etc.) satisfying a multi-factor authentication method. In this way, the clear text data can be more securely protected in an effort to thwart or prevent access to the clear text data by malicious actors. The tokenization gateway can further reduce the number of resources typically required to encrypt and decrypt clear text data in a network, as the clear text data can be tokenized using long-term tokens upon initial entry to the tokenization gateway until at time at which the clear text data can be processed. In this way, tokenized data can be passed between devices in a network so that, in some cases, only the tokenized data can be stored in databases or flat files of various network devices.

Turning now to FIG. 1C, and as shown by reference number 122, the tokenization gateway can determine and/or detect a failure, malfunction, and/or error associated with a tokenization engine and/or detokenization engine of and/or associated with the tokenization gateway. For example, in some implementations, a tokenization engine and/or a detokenization engine can fail, be taken offline, experience an error, or otherwise be unavailable to tokenize and/or detokenize the clear text data received by the tokenization gateway. In such cases, the tokenization gateway may lack the ability to perform long-term tokenization of clear text data and/or detokenization of tokenized data, as described above in FIGS. 1A-1B. As such, the tokenization gateway can be configured to implement an alternative mode (e.g., a tokenization continuity mode), by which the clear text data can be tokenized based on temporary tokens generated by the tokenization gateway as opposed to long-term tokens, as described herein.

In some implementations, the tokenization gateway can detect the failure of a tokenization engine or a detokenization engine based on a communication, notification, indication, or instruction received from an owner, operator, manager, and/or controller of the tokenization gateway. For example, the tokenization gateway can detect the failure of the tokenization engine or the detokenization engine based on a flag or status indicator that is set or communicated by an owner, operator, manager, and/or controller of the tokenization gateway, which can instruct the tokenization gateway to execute or implement a tokenization continuity mode. For example, in some cases a flag can be used to turn on and/or turn off the long-term tokenization process being implemented by the tokenization gateway. The process for turning the flag on and/or off can be specified based on predetermined procedures that can be defined or configured by the owner, operator, manager, and/or controller of the tokenization gateway.

As a specific example, where the flag is set to “on” or “true,” the tokenization gateway can tokenize and detokenize the clear text data received by the tokenization gateway as normal (e.g., using long-term tokenization processes), as described in FIGS. 1A-1B above. Additionally, or alternatively, where the flag is set to “off” or “false” (e.g., based on satisfying one or more thresholds defined or configured by an owner, etc., of the tokenization gateway), the tokenization gateway can implement a tokenization continuity mode, in which the tokenization gateway can tokenize clear text data using temporary tokens as described herein. As an example, an owner, operator, manager, and/or controller of the tokenization gateway can specify that the flag can to be set to “off” or “false” where a tokenization engine or a detokenization engine fails, is taken offline, is undergoing maintenance, is experiencing delayed response times (e.g., compared to a threshold) that exceeds a time specified by a service level agreement, is overloaded, is experiencing high transaction volumes (e.g., compared to a threshold), and/or the like.

As further shown in FIG. 1C, and by reference number 124, the tokenization gateway can implement the tokenization continuity mode based on knowledge of the failure of the tokenization engine and/or the detokenization engine to function as normal or as intended. In some implementations, when in the tokenization continuity mode, the tokenization gateway can generate temporary tokens used to tokenize the clear text data received by the tokenization gateway. In this way, the clear text data can be represented by temporary token values that cannot be computationally derivable based on knowledge of the tokens alone, despite the tokenization engine being offline and/or otherwise unavailable to tokenize the clear text data using a long-term cryptographic function. In this way, the tokenization gateway can generate and transmit the temporary tokens for storage by external devices, which precludes the ability to store the clear text data by external devices. In this way, the tokenization gateway can maintain control over which devices can access the clear text data. As a specific example, the temporary tokens can include a 16-character reference token that can be unique to the clear text data and/or a transaction involving the clear text data. The temporary token can include numeric characters (numeric digits), alphabetic characters, and/or combinations thereof. The generation of temporary tokens that are greater than or less than 16-characters is also contemplated herein.

In some implementations, the tokenization gateway can, using a continuity module of the tokenization gateway, implement the tokenization continuity mode to generate the temporary tokens based on obtaining a predetermined, predefined, or preset identifier, and generating temporary tokens that include or incorporate the identifier. The temporary tokens can be associated with clear text data and stored, for example, as data (e.g., recovery data) in a data structure of and/or assessable to the tokenization gateway. As an example, in some implementations, an owner, operator, manager, and/or controller of the tokenization gateway can specify an identifier for use in generating temporary tokens when the tokenization gateway implements the tokenization continuity mode (e.g., when a flag is set to “false” as described above). The identifier can include, for example, a predefined sequence of characters, a code, an identifier (e.g., similar to a bank identification number (BIN)) and/or the like, which can be used to identify a token as a temporary token. In some implementations, the identifier is optionally associated with a specific tokenization gateway.

As a specific example, the identifier can include a string of six to eight numeric characters (e.g., “123456”, etc.), by which the tokenization gateway can recognize that a token is a temporary token. In this way, a temporary token can be replaced with a long-term token upon termination of the tokenization continuity mode, as described herein. In some implementations, the temporary token can be based on the identifier, in contrast to the long-term token, which can be generated by way of executing a cryptographic function, as described in FIGS. 1A-1B above. The identifier can be included as the first 6-8 characters of the temporary token, or included at a random location within the temporary token, where desired. In some implementations, all of the temporary tokens generated by the tokenization gateway when in the tokenization continuity mode can include the identifier. In this way, identification of the temporary tokens and/or identification of the tokenization gateway generating the temporary tokens can be improved.

In some implementations, the temporary tokens can additionally include a variable portion, which can be different for each temporary token generated by the tokenization gateway. The variable portion can include one or more characters. As an example, the variable portion can include a randomized sequence of characters. As another example, the variable portion can be based on characters present in the clear text data and/or a reference number assigned to a transaction associated with the clear text data. For example, the variable portion can include a string of seven to nine characters that correspond to a reference number assigned to a transaction associated with the clear text data.

In some implementations, the temporary tokens can further include a validation portion that can be used to validate the temporary token. For example, the validation portion can include a validation character used to validate of the temporary token. As a specific example, the validation portion can include a character calculated based on a checksum formula (e.g., a LUHN algorithm), by which the temporary token can be validated. In some implementations, the validation portion includes a single validation character that can appear as the last character in the temporary tokens. In some implementations, the validation portion can be included in a predefined position (e.g., as the first character of the temporary token, the second character of the temporary token, etc.).

Still referring to FIG. 1C, and, when in the tokenization continuity mode, the tokenization gateway can generate and/or store recovery data in the data structure. In some implementations, the recovery data can include the temporary token, the clear text data represented by the temporary token, and timestamp information (e.g., date and/or time data) associated with generating the temporary token and/or transmitting the temporary token. In this way, the temporary token can be mapped to the clear text data and/or timestamp information for use during a recovery mode or phase as described later herein. For example, the temporary token can be converted or replaced with a long-term token upon restoration of the tokenization engine. In some implementations, the recovery data in the data structure can be encrypted using an encryption method, such as TDE. In this way, access to the temporary tokens and/or clear text data can be managed, controlled, and/or restricted.

In some implementations, the temporary tokens can be used to process real-time transactions, including, for example, purchases made using a real-time application (e.g., a wallet application). Additionally, or alternatively, the temporary tokens can be used to process batch transactions, for example, where new batch transactions are received while the tokenization gateway is in the tokenization continuity mode. In some implementations, however, the tokenization gateway can be unable to process batch applications when in the tokenization continuity mode, as the detokenization engine can be offline or otherwise unavailable. For example, in some cases, batch payments can include automatic payments set to occur at specified times, dates, and/or the like based on clear text data that was previously tokenized using a long-term token. In some implementations, during the tokenization continuity mode, the tokenization engine can encrypt batch files associated with pre-existing batch payments, queue the batch files, and save the batch files for processing at a time at which the tokenization continuity mode is terminated. Upon termination of the tokenization continuity mode, the previously tokenized clear text data can be detokenized and processed for completing batch payments.

As further shown in FIG. 1C, and by reference number 126, the tokenization gateway can receive a payment request from a real-time application for completing a real-time payment when in the tokenization continuity mode. The payment request can include encrypted clear text data. The tokenization gateway can decrypt the clear text data for use in completing the real-time payment, and tokenize the clear text data using a temporary token as described above. The clear text data can be tokenized using a temporary token at a time at which the clear text data is received by the tokenization gateway, or at a time at which a payment is authorized and/or completed based on the clear text data.

As further shown in FIG. 1C, and by reference number 128, the tokenization gateway can send data to the transaction backend device for processing. In some implementations, the tokenization gateway can send the clear text data received from the application server to the transaction backend device for processing. Alternatively, the tokenization can send tokenized data (e.g., clear text data tokenized using a temporary token) to the transaction backend device for processing. Upon processing the clear text data, the transaction backend device (e.g., a payment processor, etc.) can transmit an authorization identifier to the tokenization gateway.

As further shown in FIG. 1C, and as shown by reference number 130, the tokenization gateway can send a temporary token and the authorization identifier to the application server upon authorization and/or completion of the real-time payment. The application can store the temporary token in place of the clear text data. In this way, the clear text data used to complete the real-time payment can be tokenized using the temporary token, despite the tokenization engine being unavailable or offline. In this way, the tokenization gateway can maintain control over devices having access to the clear text data, and can transmit temporary tokens for storage by external devices, thus, obviating storage of the clear text data by the external devices.

Turning now to FIG. 1D, and as shown by reference number 132, the tokenization gateway can detect the normal functioning of the tokenization engine and/or the detokenization engine. In some implementations, the tokenization gateway detects the normal functioning of the tokenization engine and/or the detokenization engine by way of receiving or examining a status indicator or flag set by an owner, operator, manager, and/or controller of the tokenization gateway. For example, the tokenization gateway can receive an indication and/or otherwise detect that a flag has been set to “on” or “true”, as described above. As an example, the owner, operator, manager, and/or controller of the tokenization gateway can set the flag to “on” or “true” when the tokenization engine is online and/or functional to generate long-term tokens, and/or when the detokenization engine is online and/or functional.

Additionally, or, alternatively, in some implementations the tokenization gateway can automatically detect the normal functioning of the tokenization engine and/or the detokenization engine based on the occurrence of an event. For example, in some implementations, the tokenization gateway can automatically detect the normal functioning of the tokenization engine and/or the detokenization engine based on detecting that the tokenization engine and/or detokenization engine has come online, based on trial and error testing of tokenization and/or detokenization functionality (health checks), receiving a communication from the tokenization engine and/or the detokenization engine, and/or the like.

As further shown in FIG. 1D, and by reference number 134, the tokenization gateway can terminate the tokenization continuity mode. In some implementations, the tokenization gateway can terminate the tokenization continuity mode upon receiving an indication that the flag has been changed from “false” to “true”, from “off” to “on”, and/or the like.

As further shown in FIG. 1D, and by reference number 136, the tokenization gateway can initiate a recovery mode based on terminating the tokenization continuity mode. In some implementations, implementing the recovery mode can include generating a recovery file based on data contained in the data structure of the tokenization gateway. The recovery file can include long-term tokens and temporary tokens. For example, the tokenization gateway can examine the data structure and determine whether tokens contained in the data structure correspond to temporary tokens. The tokenization gateway can determine that tokens contained in the data structure correspond to temporary tokens based on detecting or recognizing the presence of the identifier. In some implementations, upon identifying the temporary tokens, the tokenization gateway can generate long-term tokens based on the clear text data associated with the temporary tokens, replace the temporary tokens with the long-term tokens, and generate and store a recovery file based on a mapping of the temporary tokens and the long-term tokens. In this way, the clear text data previously represented by the temporary tokens can be associated with long-term tokens, mapped to the long-term tokens, and stored by the tokenization gateway. In this way, the tokenization gateway can provide seamless protection of the clear text data, and reduce the number of systems and/or devices having access to the clear text data.

In some implementations, the tokenization gateway can send the recovery file, including the temporary tokens mapped to the long-term tokens, to application servers from which real-time payments were received during implementation of the tokenization continuity mode. Sending the recovery file to the application servers can cause the application servers to perform an action based on receiving the recovery file. In some implementations, the action includes replacing the temporary tokens stored by the application server with the long-term tokens generated by the tokenization gateway, based in the mapping of the temporary tokens and the long-term tokens contained in the recovery file. In this way, the application server can initiate future payments based on the long-term tokens. By virtue of replacing the temporary tokens with the long-term tokens, the application servers can be prevented from storing the temporary tokens, and can delete occurrences of the temporary tokens.

In some implementations, the tokenization gateway can perform actions for processing batch transactions based on implementing the recovery mode. For example, the transaction gateway can determine unprocessed batch files containing clear text data associated with long-term tokens, detokenize the clear text data to remove the long-term tokens, and send the unprocessed batch files to the transaction backend device for processing (payment processor).

In some implementations, the transactions completed during the tokenization continuity mode can be logged for monitoring and/or managing points of ingress and/or egress of the clear text data relative to the tokenization gateway during the tokenization continuity mode. In this way, information regarding completed transactions can be used to detect and/or prevent possible attempts by malicious actors to obtain the clear text data. In some implementations, a security monitoring or compliance entity can be notified when the flag has been changed from “true” to “false,” and/or the like, so that compliance with any security standards adopted by and/or imposed on the tokenization gateway can be monitored and/or maintained.

In this way, the clear text data received by the tokenization gateway can be tokenized using the temporary tokens, despite the tokenization engine being unavailable or offline. In this way, the tokenization gateway can maintain control over devices having access to the clear text data, and can transmit the temporary tokens for storage by external devices, thus, obviating storage of the clear text data by the external devices. In this way, the security associated with accessing the clear text data can be increased, which can inhibit unauthorized access of the clear text data by malicious actors.

As indicated above, FIGS. 1A-1D are provided merely as an example. Other examples are possible and can differ from what was described with regard to FIGS. 1A-1D.

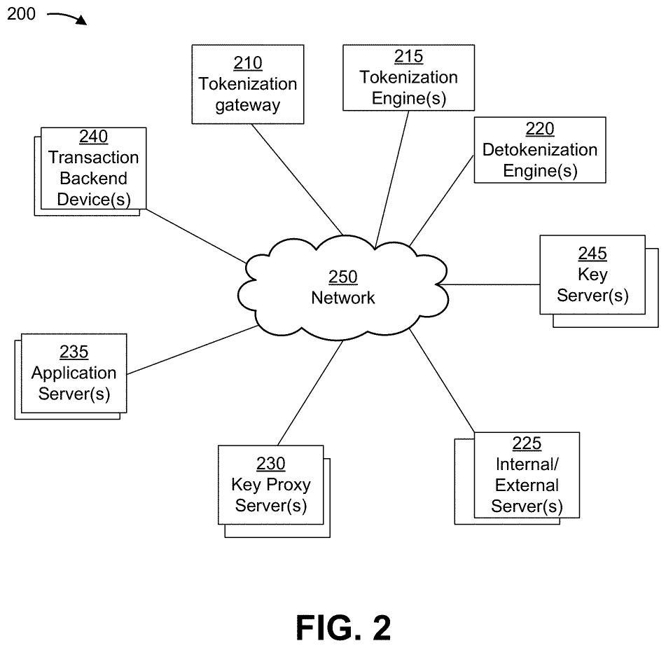

FIG. 2 is a diagram of an example environment 200 in which systems and/or methods, described herein, can be implemented. As shown in FIG. 2, environment 200 can include a tokenization gateway 210, a tokenization engine 215, a detokenization engine 220, an internal/external server 225, a key proxy server 230, an application server 235, a transaction backend device 240, a key server 245, and/or a network 250. Devices of environment 200 can interconnect via wired connections, wireless connections, or a combination of wired and wireless connections.

Tokenization gateway 210 includes one or more devices for obtaining, receiving, transmitting, storing, and/or processing clear text data. Tokenization gateway 210 can access, manage, and/or control aspects relating to tokenization and detokenization of clear text data, such as, for example, implementing a tokenization method to tokenize the clear text data, implementing a detokenization method to detokenize the clear text data, store and manage mappings of the clear text data to tokens, provide the clear text data to transaction backend devices for processing, and sending the tokenized data to application servers for processing. Tokenization gateway 210 can include, for example, one or more mainframe computers, servers, and/or a type of computational device.

Tokenization engine 215 includes a tokenization engine associated with the tokenization gateway 210 and/or a device (e.g., a server, a computer, etc.) accessible to tokenization gateway 210. Tokenization engine 215 can be provided within a computer-readable medium of tokenization gateway 210 and/or the device accessible by tokenization gateway 210. Tokenization engine 215 can perform or implement tokenization tasks to facilitate tokenization of clear text data using one or more tokenization algorithms, hashes, and/or the like, which can include, for example, tools, logic, source code, and/or the like executed by a hardware processor.

Detokenization engine 220 includes a detokenization engine associated with tokenization gateway 210 and/or a device (e.g., a server, a computer, etc.) accessible to tokenization gateway 210. Detokenization engine 220 can be provided within a computer-readable medium of tokenization gateway 210 and/or the device accessible by tokenization gateway 210. Detokenization engine 220 can perform or implement detokenization tasks to facilitate detokenization of tokenized data to obtain the original, clear text data using one or more detokenization algorithms, hashes, and/or the like, which can include, for example, tools, logic, source code, and/or the like executed by a hardware processor.

Internal/external servers 225 includes one or more server devices for obtaining, receiving, transmitting, storing, and/or processing clear text data, or, alternatively, tokenized data for implementing a service or performing an action based on the clear text data or the tokenized data. Internal/external servers 225 can be associated with a vendor, merchant, account manager, or service provider that access the clear text data or the tokenized data for performing user account analytics, credit monitoring services, user account management and/or monitoring services, and/or other services based on receiving and/or analyzing the clear text data or the tokenized data. With the use of the tokenization gateway approach the number of internal/external servers 225 having access to clear text will be greatly reduced, as the majority of the internal/external servers receive the tokenized data.

Key proxy server 230 includes one or more devices capable of passing encryption key used to encrypt clear text data entered by a user using a user device. For example, key proxy server 230 can include a server device configured to pass single-use, short-term encryption keys used to encrypt clear text data entered by a user using a user device.

Key server 245 includes one or more devices capable of managing encryption key used to encrypt clear text data. For example, key server 245 can include a server device configured to generate single-use, short-term encryption keys used to encrypt clear text data entered by a user using a user device.

Application server 235 includes one or more devices capable of sending, receiving, storing, processing, and/or providing information associated with initiating a transaction using tokenization gateway 210. For example, application server 235 can include a server device, a data center device, or a similar device. Application server 235 can be configured, for example, to receive encrypted clear text data entered by a user (e.g., using a user device such as a computer, laptop, tablet, smart device, smart phone, etc.) and send the encrypted clear text data to tokenization gateway 210 for further processing. Application server 235 can store tokens received from tokenization gateway 210 upon completion of a transaction. Application servers 235 can be associated with a merchant or service provider by which users, using user devices, can initiate transactions based on sensitive data, entered as clear text data.

Transaction backend device 240 includes one or more devices capable of obtaining, receiving, transmitting, and/or storing clear text data, or, alternatively, tokenized data, for processing, authorizing and/or completing a transaction (e.g., a payment transaction) using the clear text data or the tokenized data. For example, transaction backend device 240 can include one or more servers and/or computers to obtain, store, and/or provide information associated with processing a transaction initiated by application server 235. In some implementations, transaction backend device 240 can obtain clear text data for authorizing, approving, and/or completing a transaction, as described herein.

Transaction backend device 240 includes one or more devices associated with a financial institution (e.g., a bank, a lender, a credit union, etc.) and/or a transaction card association that authorizes a transaction and/or facilitates a transfer of funds or payment between an account associated with a user and an account of an individual or business. For example, transaction backend device 240 can include one or more devices associated with one or more issuing banks, one or more devices of one or more acquiring banks (or merchant banks), and/or one or more devices associated with one or more transaction card associations (e.g., VISA®, MASTERCARD®, and/or the like) for use in processing the clear text data to complete a purchase transaction. Accordingly, transaction backend device 240 can authorize and/or complete a transaction initiated by application server 235, generate authorization information upon authorizing and/or completing the transaction, and transmit the authorization information to tokenization gateway 210 upon authorizing and/or completing the transaction.

Network 250 includes one or more wired and/or wireless networks. For example, network 250 can include a cellular network (e.g., a long-term evolution (LTE) network, a code division multiple access (CDMA) network, a 3G network, a 4G network, a 5G network, another type of next generation network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks.

The number and arrangement of devices and networks shown in FIG. 2 are provided as an example. In practice, there can be additional devices and/or networks, fewer devices and/or networks, different devices and/or networks, or differently arranged devices and/or networks than those shown in FIG. 2. Furthermore, two or more devices shown in FIG. 2 can be implemented within a single device, or a single device shown in FIG. 2 can be implemented as multiple, distributed devices. Additionally, or alternatively, a set of devices (e.g., one or more devices) of environment 200 can perform one or more functions described as being performed by another set of devices of environment 200.

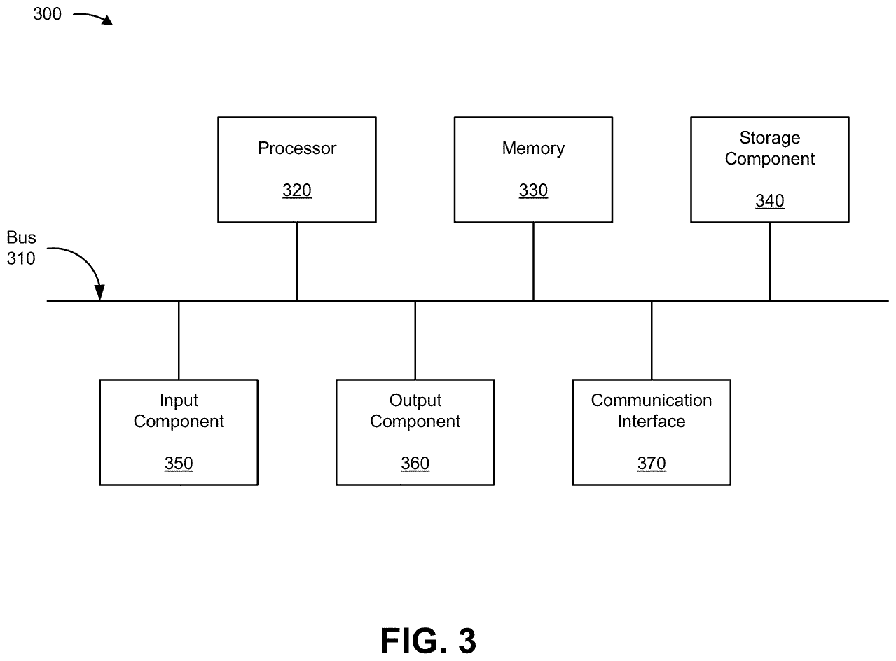

FIG. 3 is a diagram of example components of a device 300. Device 300 can correspond tokenization gateway 210, tokenization engine 215, detokenization engine 220, internal/external server 225, key proxy server 230, application server 235, transaction backend device 240, and/or key server 245. In some implementations, tokenization gateway 210, tokenization engine 215, detokenization engine 220, internal/external server 225, key proxy server 230, application server 235, transaction backend device 240, and/or key server 245 can include one or more devices 300 and/or one or more components of device 300. As shown in FIG. 3, device 300 can include a bus 310, a processor 320, a memory 330, a storage component 340, an input component 350, an output component 360, and a communication interface 370.

Bus 310 includes a component that permits communication among the components of device 300. Processor 320 is implemented in hardware, firmware, or a combination of hardware and software. Processor 320 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 320 includes one or more processors capable of being programmed to perform a function.

Memory 330 includes a random access memory (RAM), a read only memory (ROM), and/or another type of dynamic or static storage device (e.g., a flash memory, a magnetic memory, and/or an optical memory) that stores information and/or instructions for use by processor 320. One or more memories 330 can be provided.

Storage component 340 stores information and/or software related to the operation and use of device 300. For example, storage component 340 can include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

Input component 350 includes a component that permits device 300 to receive information, such as via user input (e.g., a touch screen display, a keyboard, a keypad, a mouse, a button, a switch, and/or a microphone). Additionally, or alternatively, input component 350 can include a sensor for sensing information (e.g., a global positioning system (GPS) component, an accelerometer, a gyroscope, and/or an actuator). Output component 360 includes a component that provides output information from device 300 (e.g., a display, a speaker, and/or one or more light-emitting diodes (LEDs)).

Communication interface 370 includes a transceiver-like component (e.g., a transceiver and/or a separate receiver and transmitter) that enables device 300 to communicate with other devices, such as via a wired connection, a wireless connection, or a combination of wired and wireless connections. Communication interface 370 can permit device 300 to receive information from another device and/or provide information to another device. For example, communication interface 370 can include an Ethernet interface, an optical interface, a coaxial interface, an infrared interface, a radio frequency (RF) interface, a universal serial bus (USB) interface, a wireless local area network interface, a cellular network interface, or the like.

Device 300 can perform one or more processes described herein. Device 300 can perform these processes based on processor 320 executing software instructions stored by a non-transitory computer-readable medium, such as memory 330 and/or storage component 340. A computer-readable medium is defined herein as a non-transitory memory device. A memory device includes memory space within a single physical storage device or memory space spread across multiple physical storage devices.

Software instructions can be read into memory 330 and/or storage component 340 from another computer-readable medium or from another device via communication interface 370. When executed, software instructions stored in memory 330 and/or storage component 340 can cause processor 320 to perform one or more processes described herein. Additionally, or alternatively, hardwired circuitry can be used in place of or in combination with software instructions to perform one or more processes described herein. Thus, implementations described herein are not limited to any specific combination of hardware circuitry and software.

The number and arrangement of components shown in FIG. 3 are provided as an example. In practice, device 300 can include additional components, fewer components, different components, or differently arranged components than those shown in FIG. 3. Additionally, or alternatively, a set of components (e.g., one or more components) of device 300 can perform one or more functions described as being performed by another set of components of device 300.

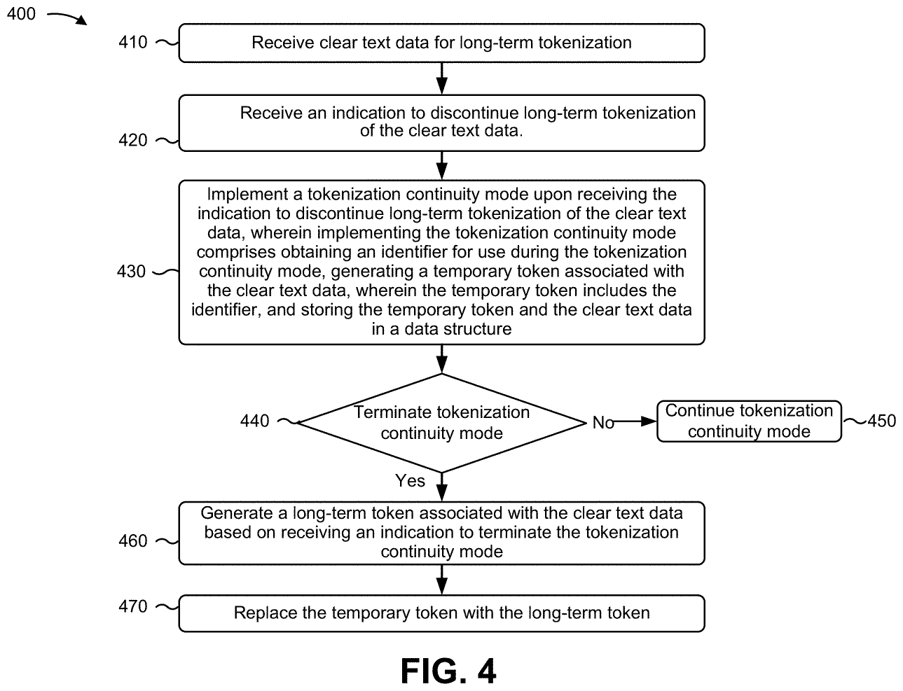

FIG. 4 is a flow chart of an example process 400 implementing a tokenization continuity mode by a tokenization device. In some implementations, one or more process blocks of FIG. 4 can be performed by a tokenization device (e.g., tokenization gateway 210). In some implementations, one or more process blocks of FIG. 4 can be performed by another device or a group of devices separate from or including a tokenization device (e.g., tokenization gateway 210), such as a tokenization engine (e.g., tokenization engine 215), a detokenization engine (e.g., detokenization engine 220), an internal/external server (e.g., internal/external server 225), a key proxy server (e.g., key proxy server 230), an application server (e.g., application server 235), and/or a transaction backend device (e.g., transaction backend device 240).

As shown in FIG. 4, process 400 can include receiving clear text data for long-term tokenization (block 410). For example, the tokenization gateway (e.g., using processor 320, input component 350, communication interface 370, and/or the like) can receive clear text data for long-term tokenization, as described above in connection with FIGS. 1A-1D.

As further shown in FIG. 4, process 400 can include receiving an indication to discontinue long-term tokenization of the clear text data (block 420). For example, the tokenization gateway (e.g., using processor 320, input component 350, communication interface 370, and/or the like) can receive an indication to discontinue long-term tokenization of the clear text data, as described above in connection with FIGS. 1A-1D.

As further shown in FIG. 4, process 400 can include implementing a tokenization continuity mode upon receiving the indication to discontinue long-term tokenization of the clear text data, wherein implementing the tokenization continuity mode comprises obtaining an identifier for use during the tokenization continuity mode, generating a temporary token associated with the clear text data, wherein the temporary token includes the identifier, and storing the temporary token and the clear text data in a data structure (block 430). For example, the tokenization gateway (e.g., using processor 320, memory 330, storage component 340, communication interface 370, and/or the like) can implement a tokenization continuity mode upon receiving the indication to discontinue long-term tokenization of the clear text data, as described above in connection with FIGS. 1A-1D. In some implementations, implementing the tokenization continuity mode comprises obtaining an identifier for use during the tokenization continuity mode, generating a temporary token associated with the clear text data, and storing the temporary token and the clear text data in a data structure. In some implementations, the temporary token includes the identifier.

As further shown in FIG. 4, process 400 can include determining whether to terminate the tokenization continuity mode (block 440). For example, the tokenization gateway (e.g., using processor 320, memory 330, storage component 340, input component 350, communication interface 370, and/or the like) can receive an indication to discontinue long-term tokenization of the clear text data in determining whether to terminate the tokenization continuity mode, as described above in connection with FIGS. 1A-1D.

As further shown in FIG. 4, if tokenization gateway 210 determines not to terminate the tokenization continuity mode (block 440—NO), then process 400 can include continuing to implement the tokenization continuity mode (block 450). For example, the tokenization gateway (e.g., using processor 320, memory 330, storage component 340, communication interface 370, and/or the like) can determine not to terminate the tokenization continuity mode and continue implementing the tokenization continuity mode, as described above in connection with FIGS. 1A-1D.

As further shown in FIG. 4, if the tokenization gateway determines to terminate tokenization continuity mode (block 440—YES), then process 400 can include generating a long-term token associated with the clear text data based on receiving an indication to terminate the tokenization continuity mode (block 460). For example, the tokenization gateway (e.g., using processor 320, memory 330, storage component 340, input component 350, communication interface 370, and/or the like) can generate a long-term token associated with the clear text data based on receiving an indication to terminate the tokenization continuity mode, as described above in connection with FIGS. 1A-1D.

As further shown in FIG. 4, process 400 can include replacing the temporary token with the long-term token (block 470). For example, the tokenization gateway (e.g., using processor 320, memory 330, storage component 340, output component 360, communication interface 370, and/or the like) can replace the temporary token, as described above in connection with FIGS. 1A-1D.

Process 400 can include additional implementations, such as any single implementation or any combination of implementations described below and/or described with regard to any other process described herein.

In some implementations, process 400 can include receiving a request for the clear text data and sending the temporary token based on receiving the request. In some implementations, process 400 can include implementing a recovery mode based on receiving the indication to terminate the tokenization continuity mode. In some implementations, implementing the recovery mode includes generating a recovery file including the long-term token and the temporary token, sending the recovery file to a device, and causing the device to perform an action based on receiving the recovery file. Additionally, or alternatively, in some implementations, implementing the recovery mode includes determining an unprocessed batch file containing the clear text data associated with a long-term token, detokenizing the clear text data to remove the long-term token, and sending the unprocessed batch file to a transaction backend device for processing.

In some implementations, process 400 can include encrypting the data structure containing the temporary token and the clear text data. In some implementations, process 400 can include providing a temporary token including the identifier, a variable portion based on characters present in the clear text data, and a validation portion used to validate the temporary token. In some implementations, the identifier is between six and eight characters, the variable portion is between seven and nine characters, and the validation portion can include one character. In some implementations, the clear text data includes a payment card number, an account number, a personal identification number (PIN), or a user identifier.

Although FIG. 4 shows example blocks of process 400, in some implementations, process 400 can include additional blocks, fewer blocks, different blocks, or differently arranged blocks than those depicted in FIG. 4. Additionally, or alternatively, two or more of the blocks of process 400 can be performed in parallel.

In this way, the number of devices that store, process, and/or transmit clear text data outside of the protected zone implemented or established by the tokenization gateway can be reduced. In this way, the opportunity for hackers and/or malicious actors to obtain the clear text data can be reduced or minimized, which increases the overall security of information in a network. The tokenization gateway can manage and control access to the tokenization engines and the detokenization engines, whereby access can be granted upon the successful presentation of two factors for a two factor authentication method. In this way, the clear text data can be more securely protected in an effort to thwart or prevent access to the clear text data by malicious actors. The tokenization gateway can further reduce the number of resources typically required to encrypt and decrypt clear text data in a network, as the clear text data can be tokenized using long-term tokens upon initial entry to the tokenization gateway until at time at which the clear text data can be processed. In this way, tokenized data can be passed between devices in a network so that only the tokenized data can be stored in databases or flat files of various network devices.

The foregoing disclosure provides illustration and description, but is not intended to be exhaustive or to limit the implementations to the precise form disclosed. Modifications and variations are possible in light of the above disclosure or can be acquired from practice of the implementations.

As used herein, the term component is intended to be broadly construed as hardware, firmware, or a combination of hardware and software.

Some implementations are described herein in connection with thresholds. As used herein, satisfying a threshold can refer to a value being greater than the threshold, more than the threshold, higher than the threshold, greater than or equal to the threshold, less than the threshold, fewer than the threshold, lower than the threshold, less than or equal to the threshold, equal to the threshold, or the like.

Certain user interfaces have been described herein and/or shown in the figures. A user interface can include a graphical user interface, a non-graphical user interface, a text-based user interface, or the like. A user interface can provide information for display. In some implementations, a user can interact with the information, such as by providing input via an input component of a device that provides the user interface for display. In some implementations, a user interface can be configurable by a device and/or a user (e.g., a user can change the size of the user interface, information provided via the user interface, a position of information provided via the user interface, etc.). Additionally, or alternatively, a user interface can be pre-configured to a standard configuration, a specific configuration based on a type of device on which the user interface is displayed, and/or a set of configurations based on capabilities and/or specifications associated with a device on which the user interface is displayed.

To the extent the aforementioned embodiments collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

It will be apparent that systems and/or methods, described herein, can be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware can be designed to implement the systems and/or methods based on the description herein.

Even though particular combinations of features are recited in the claims and/or disclosed in the specification, these combinations are not intended to limit the disclosure of possible implementations. In fact, many of these features can be combined in ways not specifically recited in the claims and/or disclosed in the specification. Although each dependent claim listed below can directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and can be used interchangeably with “one or more.” Furthermore, as used herein, the term “set” is intended to include one or more items (e.g., related items, unrelated items, a combination of related and unrelated items, etc.), and can be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A device, comprising:
one or more memories; and
one or more processors, communicatively coupled to the one or more memories, to:
receive clear text data for long-term tokenization;
receive an indication to discontinue long-term tokenization of the clear text data;
implement a tokenization continuity mode based on receiving the indication to discontinue long-term tokenization of the clear text data,
wherein, when implementing the tokenization continuity mode, the one or more processors, are to:
obtain an identifier for use during the tokenization continuity mode;
generate a temporary token associated with the clear text data,
wherein the temporary token includes the identifier; and
store the temporary token and the clear text data in a data structure;
receive an indication to terminate the tokenization continuity mode;
generate a long-term token associated with the clear text data based on receiving the indication to terminate the tokenization continuity mode; and
replace the temporary token with the long-term token.

2. The device of claim 1, wherein the one or more processors are further to:
receive, from a device, a request for the clear text data; and
send, to the device, the temporary token based on receiving the request.

3. The device of claim 1, wherein the one or more processors are further to:
implement a recovery mode based on receiving the indication to terminate the tokenization continuity mode,
wherein, when implementing the recovery mode, the one or processors are to:
generate a recovery file including the long-term token and the temporary token;
send the recovery file to a device; and
cause the device to perform an action based on receiving the recovery file.

4. The device of claim 1, wherein the one or more processors are further to:
implement a recovery mode based on receiving the indication to terminate the tokenization continuity mode,
wherein, when implementing the recovery mode, the one or processors are to:
determine an unprocessed batch file containing the clear text data associated with the long-term token;
detokenize the clear text data to remove the long-term token; and
send the unprocessed batch file to a transaction backend device for processing.

5. The device of claim 1, wherein the one or more processors are further to:
encrypt the data structure containing the temporary token and the clear text data.

6. The device of claim 1, wherein the temporary token includes:
the identifier,
wherein the identifier is between six and eight characters;
a variable portion,
wherein the variable portion is based on characters present in the clear text data, and
wherein the variable portion is between seven and nine characters; and
a validation portion used to validate of the temporary token,
wherein the validation portion is one character.

7. The device of claim 1, wherein the clear text data comprises:
a payment card number,
an account number,
a personal identification number (PIN),
a user identifier.

8. A non-transitory computer-readable medium storing instructions, the instructions comprising:
one or more instructions that, when executed by one or more processors of a device, cause the one or more processors to:
receive clear text data for long-term tokenization;
receive an indication to discontinue long-term tokenization of the clear text data;
implement a tokenization continuity mode upon receiving the indication to discontinue long-term tokenization of the clear text data,
wherein, when implementing the tokenization continuity mode, the one or more instructions, that when executed by one or more processors of the device, cause the one or more processors, to:
obtain an identifier for use during the tokenization continuity mode;
generate a temporary token associated with the clear text data,
wherein the temporary token includes the identifier; and
store the temporary token and the clear text data in a data structure;
receive an indication to terminate the tokenization continuity mode;
generate a long-term token associated with the clear text data based on receiving the indication to terminate the tokenization continuity mode; and
replace the temporary token with the long-term token.

9. The non-transitory computer-readable medium of claim 8, wherein the one or more instructions, that when executed by one or more processors of the device, cause the one or more processors, to:
receive, from a device, a request for the clear text data; and
send, to the device, the temporary token based on receiving the request.

10. The non-transitory computer-readable medium of claim 8, wherein the one or more instructions, that when executed by one or more processors of the device, cause the one or more processors, to:
implement a recovery mode based on receiving the indication to terminate the tokenization continuity mode,
wherein the one or more instructions, that cause the one or more processors to implement the recovery mode, cause the one or more processors to:
generate a recovery file including the long-term token and the temporary token;
send the recovery file to a device; and
cause the device to perform an action based on receiving the recovery file.

11. The non-transitory computer-readable medium of claim 8, wherein the one or more instructions, that when executed by one or more processors of the device, cause the one or more processors, to:
implement a recovery mode based on receiving the indication to terminate the tokenization continuity mode,
wherein the one or more instructions, that cause the one or more processors to implement the recovery mode, cause the one or more processors to:
determine an unprocessed batch file containing the clear text data associated with the long-term token;
detokenize the clear text data to remove the long-term token; and
send the unprocessed batch file to a transaction backend device for processing.

12. The non-transitory computer-readable medium of claim 8, wherein the one or more instructions, that when executed by one or more processors of the device, cause the one or more processors, to:
encrypt the data structure containing the temporary token and the clear text data.

13. The non-transitory computer-readable medium of claim 8, wherein the temporary token comprises:
the identifier,
wherein the identifier is between six and eight characters;
a variable portion,
wherein the variable portion is based on characters present in the clear text data, and
wherein the variable portion is between seven and nine characters; and
a validation portion used to validate of the temporary token,
wherein the validation portion is one character.

14. The non-transitory computer-readable medium of claim 8, wherein the clear text data comprises:
a payment card number,
an account number,
a personal identification number (PIN), or
a user identifier.

15. A method, comprising:
receiving, by a processor, clear text data for long-term tokenization;
receiving, by the processor, an indication to discontinue long-term tokenization of the clear text data;
implementing, by the processor, a tokenization continuity mode upon receiving the indication to discontinue the long-term tokenization of the clear text data,
wherein implementing the tokenization continuity mode comprises:
obtaining, by the processor, an identifier for use during the tokenization continuity mode;
generating, by the processor, a temporary token associated with the clear text data,
wherein the temporary token induces the identifier; and
storing, by the processor, the temporary token and the clear text data in a data structure;
receiving, by the processor an indication to terminate the tokenization continuity mode;
generating, by the processor, a long-term token associated with the clear text data based on receiving the indication to terminate the tokenization continuity mode; and
replacing, by the processor, the temporary token with the long-term token.

16. The method of claim 15, further comprising:
receiving, from a device, a request for the clear text data; and
sending, to the device, the temporary token based on receiving the request.

17. The method of claim 15, further comprising:
implementing a recovery mode based on receiving the indication to terminate the tokenization continuity mode,
wherein the recovery mode comprises:
generating a recovery file including the long-term token and the temporary token;
sending the recovery file to a device; and
causing the device to perform an action based on receiving the recovery file.

18. The method of claim 15, further comprising:
implementing a recovery mode based on receiving the indication to terminate the tokenization continuity mode,
wherein the recovery mode comprises:
determining an unprocessed batch file containing the clear text data associated with the long-term token;
detokenizing the clear text data to remove the long-term token; and
sending the unprocessed batch file to a transaction backend device for processing.

19. The method of claim 15, further comprising encrypting the data structure containing the temporary token and the clear text data.

20. The method of claim 15, wherein the temporary token includes:
the identifier,
wherein the identifier is between six and eight characters;
a variable portion,
wherein the variable portion is based on characters present in the clear text data, and
wherein the variable portion is between seven and nine characters; and
a validation portion used to validate of the temporary token,
wherein the validation portion is one character.
